(19) United States
(12) Patent Application Publication
(10) Pub. No.: US 2015/0293378 A1
(43) Pub. Date: Oct. 15, 2015

(54) AUXILIARY APPARATUS TO REDUCE LIGHT POLLUTION AND ENHANCE EYE CONCENTRATION

(71) Applicant: Ming-Fu CHOU, Taichung City (TW)

(72) Inventor: Ming-Fu CHOU, Taichung City (TW)

(21) Appl. No.: 14/249,109

(22) Filed: Apr. 9, 2014

(51) Int. Cl. G02C 7/16; G02C 9/04; G02C 5/14

(52) U.S. Cl. CPC G02C 7/16; G02C 5/14; G02C 9/04

(57) ABSTRACT

An auxiliary apparatus to reduce light pollution and enhance eye concentration to be used on user's eyes includes at least one viewing window and a frame. The viewing window has an opaque mask zone and a transparent zone formed in the center of the mask zone. The frame is positioned on user's eyes to hold the viewing window. Through the viewing window, excessive light from outside can be masked by the mask zone to reduce light pollution to user's eyes. Moreover, through the transparent zone, user can concentrate the eyesight on an intended viewing area without being interfered by surroundings, thereby can enhance concentration.

### FIELD OF THE INVENTION

The present invention relates to an eyesight auxiliary apparatus and particularly to an auxiliary apparatus to reduce light pollution and enhance eye concentration.

### BACKGROUND OF THE INVENTION

Advance of technology has spawned a great deal of technology products that become indispensible to the life of modern people, such as 3C products, including televisions, personal computers and smartphones. The computers are often being used in work, smartphones for handling various chores and TVs for relaxing while in rest.

While the 3C products bring a lot of convenience and entertainment to people's life, people also have spent a great deal of time watching the screens of the 3C products. People's eyes are easily harmed by light pollution as staring at the screens at a short distance. This could result in deterioration of eyesight and even eye ailments.

Moreover, maintaining concentration is vital to get desired efficiency and productivity when in work. But in an open work environment, distraction affected by surroundings is unavoidable. As a result, people's attention often is interrupted and thought is disrupted and work efficiency suffers.

### SUMMARY OF THE INVENTION

The primary object of the present invention is to reduce user's eye injury caused by light pollution generated by screens while watching the screens at a short distance.

Another object of the invention is to enable user to pay more attention on an intended viewing area without being interfered by surroundings to enhance user's concentration.

To achieve the foregoing objects the invention provides an auxiliary apparatus to reduce light pollution and enhance eye concentration. The auxiliary apparatus includes at least one viewing window and a frame positioned on user's eyes to hold the viewing window. The viewing window has an opaque mask zone and a transparent zone formed in the center of the mask zone. User can put on the auxiliary apparatus on his/her eyes. Through the transparent zone, user can concentrate the eyesight to the intended reading area without being interfered by surroundings. The mask zone can block light outside the reading zone to alleviate the burden of the eyes, thereby reduce the impact of light pollution.

By means of the aforesaid structure and technique, the invention can provide many beneficial features, notably:

1. Through the viewing window, a great portion of light from the screen can be blocked by the mask zone without reaching user's eyes, therefore can reduce light pollution.

2. Through the transparent zone, user can concentrate on the intended viewing area without being interfered by surroundings, hence can enhance concentration.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a first embodiment of the invention.

FIG. 2 is a perspective view of a second embodiment of the invention.

FIG. 3A is a schematic view of a viewable scope of the auxiliary apparatus of the invention.

FIG. 3B is a schematic view of another viewable scope of the auxiliary apparatus of the invention.

FIG. 4 is a perspective view of a third embodiment of the invention.

FIG. 5 is a perspective view of a fourth embodiment of the invention.

FIG. 6 is a perspective view of a fifth embodiment of the invention.

### DETAILED DESCRIPTION OF THE PREFERRED EMBODIMENTS

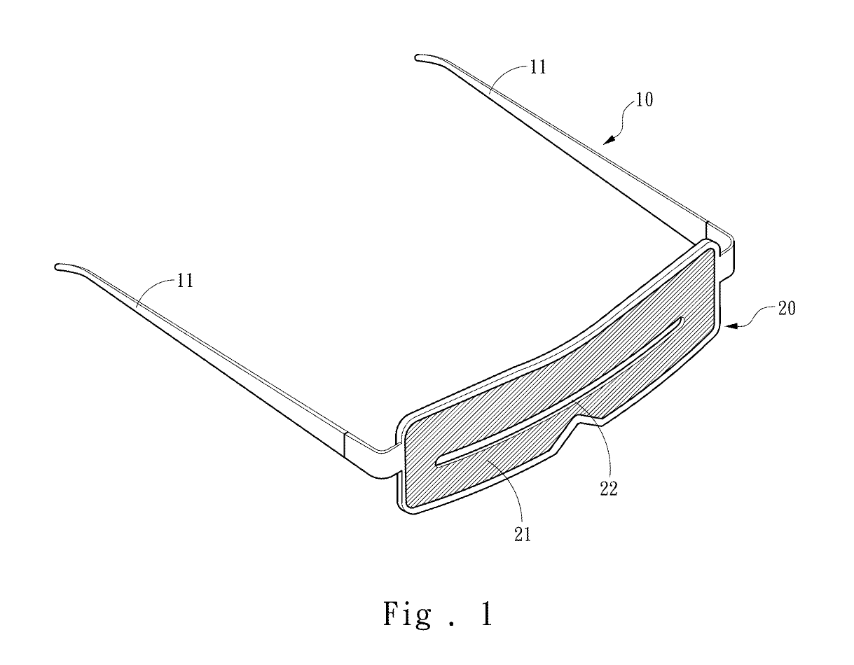

Please refer to FIGS. 1, 2, 3A and 3B, the present invention aims to provide an auxiliary apparatus to reduce light pollution and enhance eye concentration that is used on a user's eyes. The auxiliary apparatus includes at least one viewing window 20 and a frame 10 corresponding to and holding the viewing window 20. The viewing window 20 has an opaque mask zone 21 and a transparent zone 22 formed in the center of the mask zone 21. The frame 10 includes a wearing section 11 extended to user' ears. It is to be noted that the transparent zone 22 can be formed by perforating on the opaque viewing window 20, or the mask zone 21 and transparent zone 22 can be formed by coating the transparent viewing window 20 in black or bonding light masking material thereon.

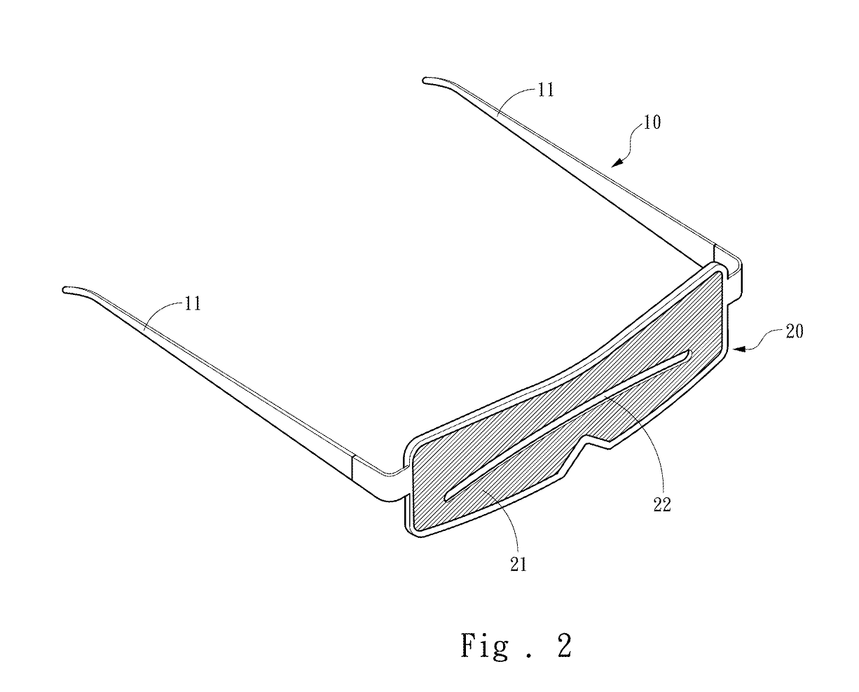

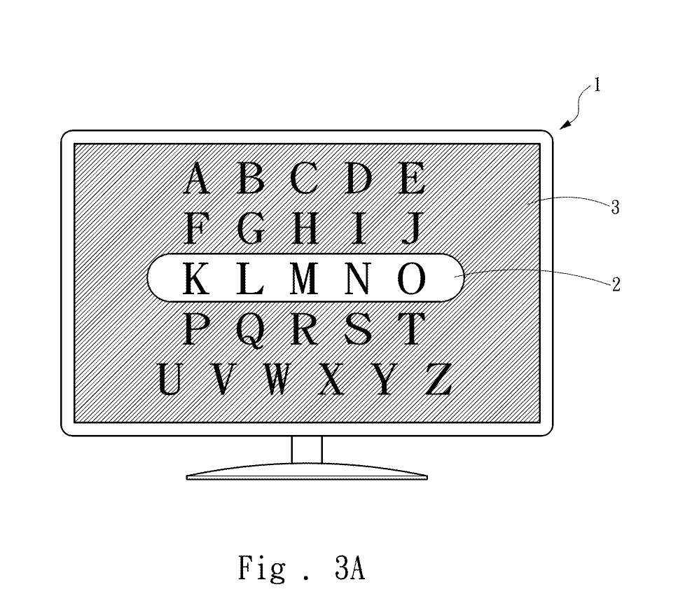

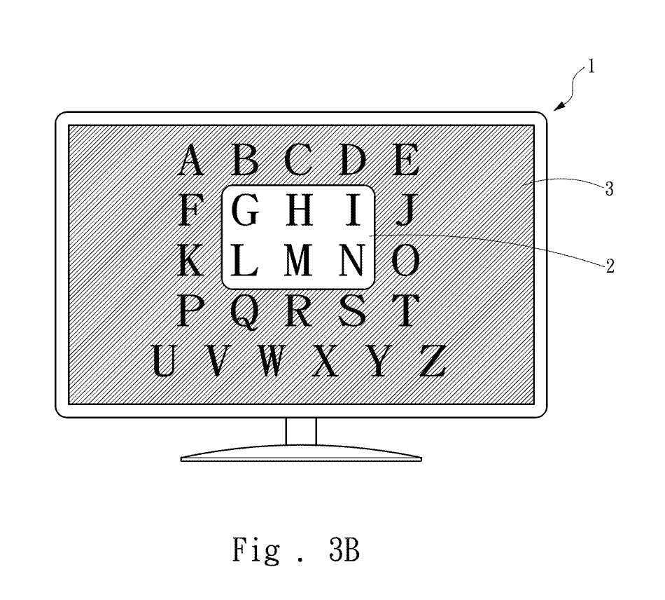

Please refer to FIG. 1, the auxiliary apparatus is eyeglasses which include the frame 10 being an eyeglasses frame and at least one viewing window 20 being an integrated lens with one mask zone 21 and one transparent zone 22. Furthermore, referring to FIG. 2 for a second embodiment, the transparent zone 22 can be formed in a rectangular or an arched shape. When a user has put on the auxiliary apparatus, user's vision is confined to the transparent zone 22 to concentrate on a viewing area 2 of a reading object 1 without being affected by a non-viewing area 3 to enhance concentration, as shown in FIGS. 3A and 3B. In addition, the reading object 1 can be a computer screen. When the user has put on the auxiliary apparatus, the mask zone 21 can block extra light from the computer screen to reduce fatigue of the eyes caused by receiving too much light pollution while reading or watching the computer screen at a short distance.

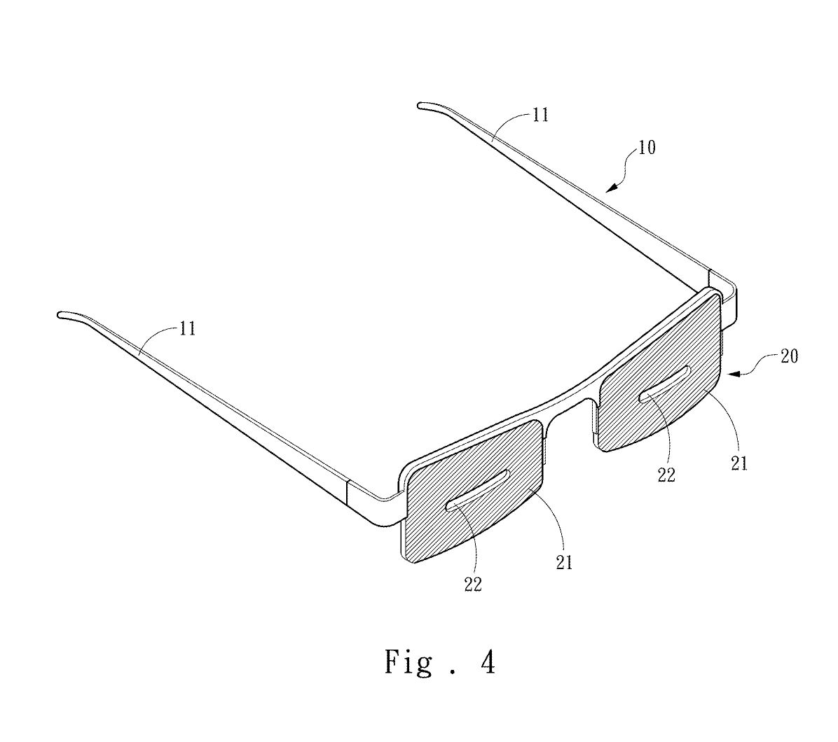

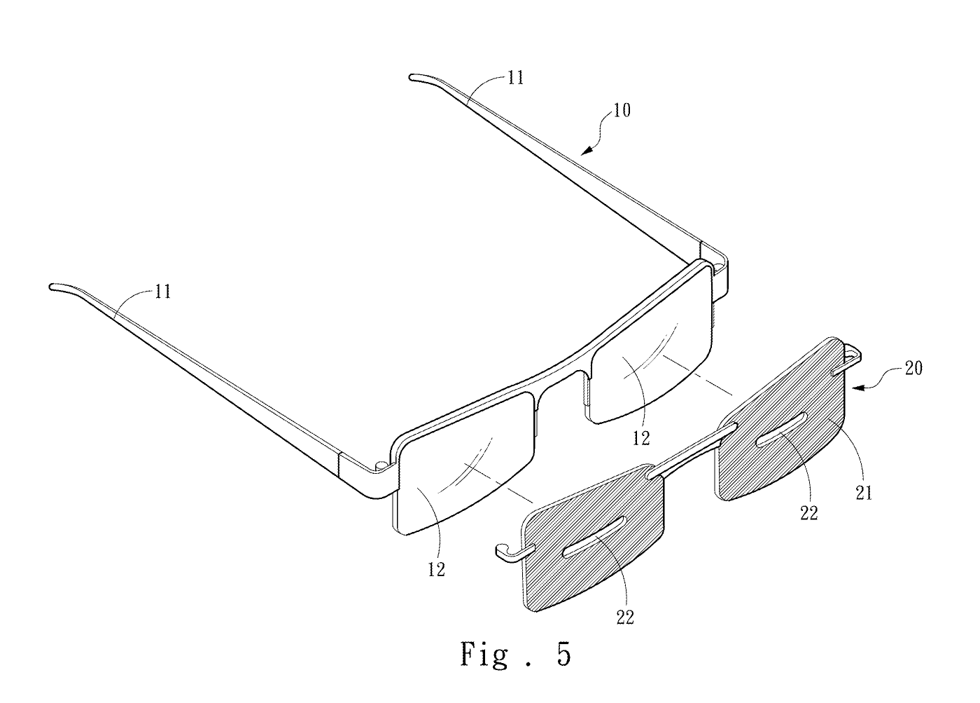

Please refer to FIG. 4 for a third embodiment. The viewing window 20 has two opaque lenses each having one transparent zone 22 in the center thereof so that the user can easily put on the auxiliary apparatus like wearing eyeglasses. FIG. 5 illustrates a fourth embodiment in which the spectacles frame further includes lenses 12 which can be nearsighted eyeglasses with a prescriptive optical power. The viewing window 20 is an externally attached lens which can be coupled on the spectacles frame by clipping or magnetic attraction or the like so that the auxiliary apparatus also can provide corrective function for near sight at the same time.

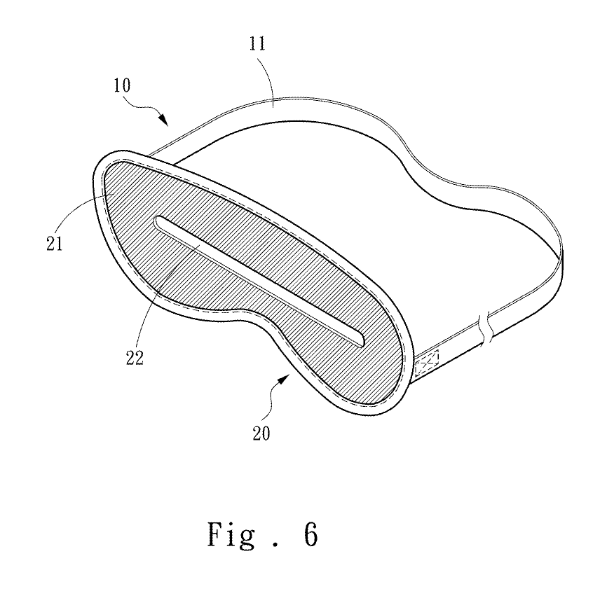

FIG. 6 shows a fifth embodiment of the auxiliary apparatus that is an eyeshade with the transparent zone 22 corresponding to the eyes.

It is also to be noted that the auxiliary apparatus of the invention, according to actual requirements, can be eyeglasses, an eyeshade, or a handheld gadget, or coupled with a hat.

As a conclusion, the invention provides features as follows:

1. Through the viewing window, a great portion of light pollution from the screen can be masked by the mask zone to reduce injury of eyes caused by staring at the computer screen at a short distance.

2. Through the transparent zone, user can focus on the intended viewing area without being interfered by surroundings, hence can enhance concentration.

3. Using the eyeglasses or eyeshade as the auxiliary apparatus, wearing is simpler for the user.

4. Through the externally attached lenses, it can be incorporated with the nearsighted eyeglasses when in use.

What is claimed is:

1. An auxiliary apparatus to reduce light pollution and enhance eye concentration used on user's eyes, comprising:
at least one viewing window which includes an opaque mask zone and a transparent zone formed in a center of the mask zone; and
a frame positioned on the user's eyes for holding the at least one viewing window.

2. The auxiliary apparatus of claim 1, wherein the auxiliary apparatus is eyeglasses and the frame is an eyeglasses frame.

3. The auxiliary apparatus of claim 2, wherein the at least one viewing window includes two opaque lenses.

4. The auxiliary apparatus of claim 2, wherein the eyeglasses frame further includes a transparent eyeglasses lens, the at least one viewing window being an externally coupled lens.

5. The auxiliary apparatus of claim 1, wherein the auxiliary apparatus is an eyeshade.

6. The auxiliary apparatus of claim 1, wherein the frame includes a wearing section extended to user's ears.
